(19) United States
(12) Patent Application Publication
(10) Pub. No.: US 2016/0333896 A1
(43) Pub. Date: Nov. 17, 2016

(54) ACCUMULATOR DEVICE

(71) Applicant: HYDAC TECHNOLOGY GMBH, Sulzbach/Saar (DE)

(72) Inventors: Herbert BALTES, Losheim (DE); Peter KLOFT, Ransbach-Baumbach (DE)

(73) Assignee: HYDAC TECHNOLOGY GMBH, Sulzbach/Saar (DE)

(21) Appl. No.: 15/111,203

(22) PCT Filed: Dec. 19, 2014
(86) PCT No.: PCT/EP2014/003445

§ 371 Date: Jul. 13, 2016

(30) Foreign Application Priority Data
Jan. 14, 2014 (DE) 10 2014 000 380.9

(51) Int. Cl. F15B 1/24

(52) U.S. Cl. CPC F15B 1/24; F15B 2201/31; F15B 2201/405

(57) ABSTRACT

The invention relates to an accumulator device, in particular in the form of a piston accumulator, having a dividing piston (22) which inside an accumulator housing (2) separates two media chambers (26, 28) from each other, and in particular separates a chamber (28) containing a working gas, such as nitrogen, from a chamber (26) containing a working fluid, such as hydraulic oil. The invention is characterized in that the dividing piston (22) is longitudinally movably guided in a guide device (24) and that the guide device (24) is arranged inside the accumulator housing (2) and extends at least partially along the longitudinal axis (10) thereof.

The invention relates to an accumulator device, in particular in the form of a piston accumulator, having a floating piston, which inside an accumulator housing separates two media chambers from each other, and in particular separates a chamber containing a working gas, such as nitrogen, from a chamber containing a working fluid, such as hydraulic oil.

Accumulator devices of this type are known in a variety of sizes and embodiments and are available on the market. They are widely used in hydraulic systems of various kinds, for example for storing hydraulic energy, for damping or smoothing pressure fluctuations and the like. Frequently accumulator devices in the form of piston accumulators are also used in hydraulic systems in working equipment having hydraulic drive units, for instance mobile machines, such as excavators, forklifts, loaders or mobile cranes.

In view of the fact that, due to the varied and numerous applications, accumulator devices are to be produced in large quantities, the amount of manufacturing costs constitutes an economically extremely important factor. In this regard, the invention addresses the problem of providing an accumulator device of the aforementioned type, which can be produced particularly efficiently and cost-effectively and which, moreover, is characterized by a particularly favorable operational behavior.

According to the invention, this problem is solved by an accumulator device having the features of Claim 1 in its entirety.

According to the characterizing part of Claim 1 one essential feature of the invention is that the floating piston is longitudinally movably guided in a guiding means and that the guiding means is arranged inside the accumulator housing and extends at least partially along the longitudinal axis thereof. Because according to the invention, a guiding means is provided for the floating piston within the accumulator housing, the accumulator housing can be produced efficiently and at low cost because no expensive internal machining is required for a direct guiding of the floating piston on the inner wall of the housing.

A particular advantage of the invention is that an identical unit consisting of a guiding means and the associated floating piston, can be used for varying accumulator housing sizes, whereby a modular design can be realized for the production of accumulator devices having varying dimensions, resulting in a particularly efficient production at low cost. The presence of a guiding means extending in the longitudinal direction of the accumulator housing further improves the performance by homogenizing the working gas due to reduced turbulence occurring during operation.

The longitudinal extension of the guiding means may be sized such that the floating piston remains in the guiding means in every possible movement position thereof.

In a particularly advantageous manner, the guiding means can be formed of a hollow cylinder, preferably having uniform wall thickness, whose free end is fixed on the inside of the accumulator housing. A corresponding hollow cylinder, at whose wall there is no pressure gradient due to the movability of the floating piston in operation, can be produced relatively inexpensively because of the thin walls and can be attached to the inside of the housing by a weld.

The guiding means may be advantageously incorporated into the housing, in such a manner that the floating piston uses parts of the guiding means and the parts of the accumulator housing, at which one end of the hollow cylinder has been fastened in an impermeable manner, to delimit the media chamber holding the working fluid.

In doing so the said parts of the accumulator housing can be part of an upper housing part, in particular in the form of a cover, which follows on its inside at least in part the free frontal outer contour of the floating piston, which faces the upper housing part. If the working fluid is not pressurized, this results in a reliable, full-surface contact of the floating piston at the housing wall.

For this purpose, the frontal outer contour of the floating piston can be convex in order to rest against the concave inside of the upper housing part as soon as the floating piston has reached one of its end positions, wherein the working fluid is completely displaced from the assignable media chamber.

Advantageously, the accumulator housing and the guiding means are arranged largely concentrically to each other, the outer side of the guiding means maintaining at least over a central part of the accumulator housing a constant distance from the inside of the accumulator housing.

The arrangement can advantageously be made in such a manner that the free end of the guiding means leads into the direction of a bottom part of the accumulator housing, which, being designed as a hemisphere, is preferably an integral part of the cup-shaped lower part of the housing.

The longitudinal extension of the hollow cylinder forming the guiding means can be designed with particular advantage such that the free end of the guiding means terminates in a transition area in which the cylindrically shaped central part of the accumulator housing merges into the hemispherical bottom part of the housing.

The accumulator housing may be formed with particular advantage such that a weld joint between the upper housing part and the adjoining housing part is covered by the guiding means while maintaining a predetermined radial distance.

The guiding means thus forms a protective cover of the weld during welding.

The invention is explained in detail below using an exemplary embodiment depicted in the drawing.

In the drawings:

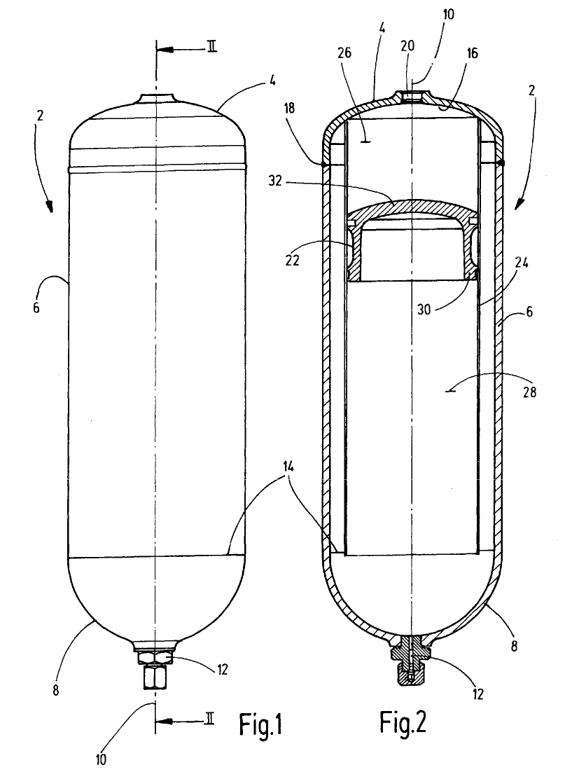

FIG. 1 shows a side view of an exemplary embodiment of the accumulator device according to the invention and

FIG. 2 shows a longitudinal section along the line II-II of FIG. 1.

The exemplary embodiment depicted in the figures has an accumulator housing 2 having a circular-cylindrical main housing part 6, an upper housing part 4 and a bottom part 8. The main housing part 6 and the bottom part 8 form a cup, which is closed except for a gas-filling connector 12 located coaxially to the longitudinal axis 10 of the accumulator. The main housing part 6 and the bottom part 8 are integrally formed, for instance in the form of a deep-drawn part made of a metallic material, said bottom part 8 having the shape of a hemisphere, which merges into a transition region 14 in the cylindrical main housing part 6. The upper housing part 4 has the shape of a shell with a concavely shaped inside 16 and is connected by means of a weld 18 to the cylindrical main housing part 6 as a fastener of the housing 2. A fluid port 20 is provided concentrically to the longitudinal axis 10 on the upper housing part 4 for an working fluid concerned, such as hydraulic oil.

Although the accumulator device forms a piston accumulator, the accumulator housing 2 is designed in the manner of a housing for a bladder accumulator, i.e. the surface of the inside of the housing 2 is not machined, as is required for conventional piston-type accumulators to form a sliding and guiding surface for the respective floating piston, in a simple and inexpensive manner, as in the invention this function is taken over by a guiding means of the floating piston 22. It has a hollow cylinder 24, which extends into the housing 2 concentrically to the axis 10 and on the inside forms the guide track for the floating piston 22. One end of the hollow cylinder 24 is impermeably fixed to the upper housing part 4 by welding and its opposite free end extends into the transition area 14, where the cylindrical main housing part 6 merges into the bottom part 8. As the upper end of the hollow cylinder 24 is impermeably closed by the upper housing part 4, the space above the floating piston 22 located in the hollow cylinder 24 forms the fluid side, separated from the gas side 28, which is located in the remaining part of the hollow cylinder 24 and outside its open aperture in the remaining housing area, adjacent to the bottom part 8, by the floating piston 22. As can be seen in FIG. 2, the floating piston 22 has the shape of a cup, the depth of which is determined by the axial extension of a piston skirt 30, which extends downwards from the cup bottom 32, overhead in FIG. 2. The axial length of the piston skirt 30 is dimensioned such that at the end position of the traversing position occupied by the floating piston 22 in the absence of pressurized working gas, [the cup] contacts the bottom part 8 with its piston skirt 30. For this axial length of the hollow cylinder 24, whose open end extends at least into the transition area 14 between the bottom part 8 and the main part 6, the floating piston 22 therefore remains at the lower end position in guiding engagement with the hollow cylinder 24.

As can be seen, the upper surface of the cup bottom 32 of the floating piston 22 is convexly curved, the curvature being adapted to the concave curvature of the inside 16 of the upper housing part 4 in such a manner that the floating piston 22 in its upper end position, i.e. in the absence of fluid pressure, contacts the inside 16 over the complete surface. Thus, at this end position, the accumulator body 2 is free of any residual volume of remaining liquid.

As in operation the floating piston 22 in the hollow cylinder takes a position corresponding to the pressure balance between the fluid side 26 and gas side 28, no differential pressure is effective on the wall of the hollow cylinder 24, i.e. the hollow cylinder 24 can be formed as a thin-walled tube using very little material. The assembly consisting of a hollow cylinder 24 and a floating piston 22 can be used as a prefabricated module or block for varying accumulator designs. Optionally, for the same tube diameter and identically constructed floating piston 22, varying pipe lengths can be provided for different lengths of the accumulator housing. In this way, the invention allows for a cheap construction of accumulator devices in the form of piston accumulators.

1. An accumulator device, in particular in the form of a piston accumulator, having a floating piston (22), which inside an accumulator housing (2) separates two media chambers (26, 28) from each other, and in particular separates a chamber (28) containing a working gas, such as nitrogen, from a chamber (26) containing a working fluid, such as hydraulic oil, characterized in that the floating piston (22), within a guiding means (24), is guided to be longitudinally displaceable and that the guiding means (24), which is arranged inside the accumulator housing (2), extends at least partially along the longitudinal axis (10) thereof.

2. The accumulator device according to claim 1, characterized in that the longitudinal extension of the guiding means (24) is dimensioned such that in every possible movement position of the floating piston (22) it remains in the guiding means (24).

3. The accumulator device according to claim 1, characterized in that the guiding means is formed by a hollow cylinder (24), preferably having a uniform wall thickness, one free end of which is fixed on the inside (16) of the accumulator housing (2).

4. The accumulator device according to claim 1, characterized in that the floating piston (22) uses parts of the guiding means (24) and the parts (4, 16) of the accumulator housing (2), at which one end of the hollow cylinder (24) has been fastened in an impermeable manner, to delimit the media chamber (26) holding the working fluid.

5. The accumulator device according to claim 1, characterized in that said parts of the accumulator housing (2) are parts of an upper housing part (4), particularly in the form of a lid, which follows on its inside (16) at least in part the free frontal outer contour (32) of the floating piston (22), facing the upper housing part (4).

6. The accumulator device according to claim 1, characterized in that the frontal outer contour (32) of the floating piston (22) is convexly shaped in order to rest against the concave inside (16) of the upper housing part (4) as soon as the floating piston (22) has reached its end position, in which the working fluid is completely displaced from one of the assignable media chambers (26).

7. The accumulator device according to claim 1, characterized in that the accumulator housing (2) and the guiding means (24) are arranged largely concentrically to each other and in that at least over a central part (6) of the accumulator housing (2), the outside of the guiding means (24) maintains a constant distance to the inside of the accumulator housing (2).

8. The accumulator device according to claim 1, characterized in that the free end of the guiding means (24) leads into the direction of a bottom part (8) of the accumulator housing (2), which, being designed as a hemisphere, is preferably an integral part of the cup-shaped main housing part (6).

9. The accumulator device according to claim 1, characterized in that the free end of the guiding means (24) terminates in a transition area (14) in which the cylindrically shaped central part of the accumulator housing (6) merges into the hemispherical bottom part (8) of the housing (2).

10. The accumulator device according to claim 1, characterized in that a weld joint (18) between the upper housing part (4) and the adjoining housing part (6) is covered by the guiding means (24) while maintaining a predetermined radial distance.
